(19) United States
(12) Patent Application Publication
(10) Pub. No.: US 2010/0054713 A1
(43) Pub. Date: Mar. 4, 2010

(54) VIDEO REPRODUCING APPARATUS

(75) Inventor: Michio Yamashita, Inagi-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/411,235

(22) Filed: Mar. 25, 2009

(30) Foreign Application Priority Data
Aug. 28, 2008 (JP) 2008-219685

(51) Int. Cl. H04N 5/00

(52) U.S. Cl. 386/124; 386/E05.001

(57) ABSTRACT

A video reproducing apparatus includes: a plurality of image generating modules each configured to repeatedly generate video image from a video content simultaneously for each of chapters contained in the video content; and an image processing module configured to combine the video images generated by the image generating modules into a single video information and to output the video information.

### CROSS REFERENCE TO RELATED APPLICATION(S)

The present disclosure relates to the subject matters contained in Japanese Patent Application No. 2008-219685 filed on Aug. 28, 2008, which are incorporated herein by reference in its entirety.

### FIELD

The present invention relates to a video reproducing apparatus and method for reproducing video data containing chapter data.

### BACKGROUND

With prevalence of digital contents such as a DVD (Digital Versatile Disc) or digital broadcasting, video distribution in the form of a video image (motion image) has become widely utilized. In such video contents, in order to allow the user to indicate a desired reproduction position, a method in which a chapter is designated as video delimitation is usually employed. A technique has been proposed in which still images respectively corresponding to videos at designated chapter positions are displayed on a screen to show to the user the contents of the designated chapter positions. An example of such technique is disclosed in JP-A-2008-085724.

In some of video contents, an original context can be expressed only by showing an image displayed on a screen in the form of a motion image. In such a case, even when a still image which is extracted from the video image in accordance with a predetermined rule is shown, the user can sometimes hardly understand the content of the chapter.

In video contents, even when the contents of a chapter are shown in the form of a still image of a predetermined timing, there is a case where the context of the chapter cannot be understood.

### SUMMARY

Therefore, one of objects of the invention is to provide a video reproducing apparatus, a video reproducing method, and a video reproducing program which facilitate recognition of chapter contents contained in video contents.

According to an aspect of the present invention, there is provided a video reproducing apparatus including: a plurality of image generating modules each configured to repeatedly generate video image from a video content simultaneously for each of chapters contained in the video content; and an image processing module configured to combine the video images generated by the image generating modules into a single video information and to output the video information.

According to another aspect of the present invention, there is provided a method for reproducing video, the method including: repeatedly generating video image from a video content simultaneously for each of chapters contained in the video content by a plurality of image generating modules; and combining the video images by an image processing module into a single video information to output the video information.

According to another aspect of the present invention, there is provided a computer-readable storage medium containing a program executable by a computer system to cause the computer system to operate in accordance with a sequence of procedure, the procedure including: repeatedly generating video image from a video content simultaneously for each of chapters contained in the video content by a plurality of image generating modules; and combining the video images by an image processing module into a single video information to output the video information.

### BRIEF DESCRIPTION OF THE DRAWINGS

A general configuration that implements the various feature of the invention will be described with reference to the drawings. The drawings and the associated descriptions are provided to illustrate embodiments of the invention and not to limit the scope of the invention.

FIG. 1 is a view showing an example of a video reproducing system in an embodiment.

FIG. 2 is a view showing an example of a block diagram of a video reproducing apparatus in the embodiment.

FIG. 3 is a view showing an example of a functional block diagram of the video reproducing apparatus in the embodiment.

FIG. 4 is a view showing an example of a video image display screen in the embodiment.

FIG. 5 is a view showing an example of a motion image display flow in the embodiment.

FIG. 6 is a view showing an example of a full-screen display flow in the embodiment.

FIG. 7 is a view showing an example of a chapter display flow in the embodiment.

### DETAILED DESCRIPTION OF THE EMBODIMENTS

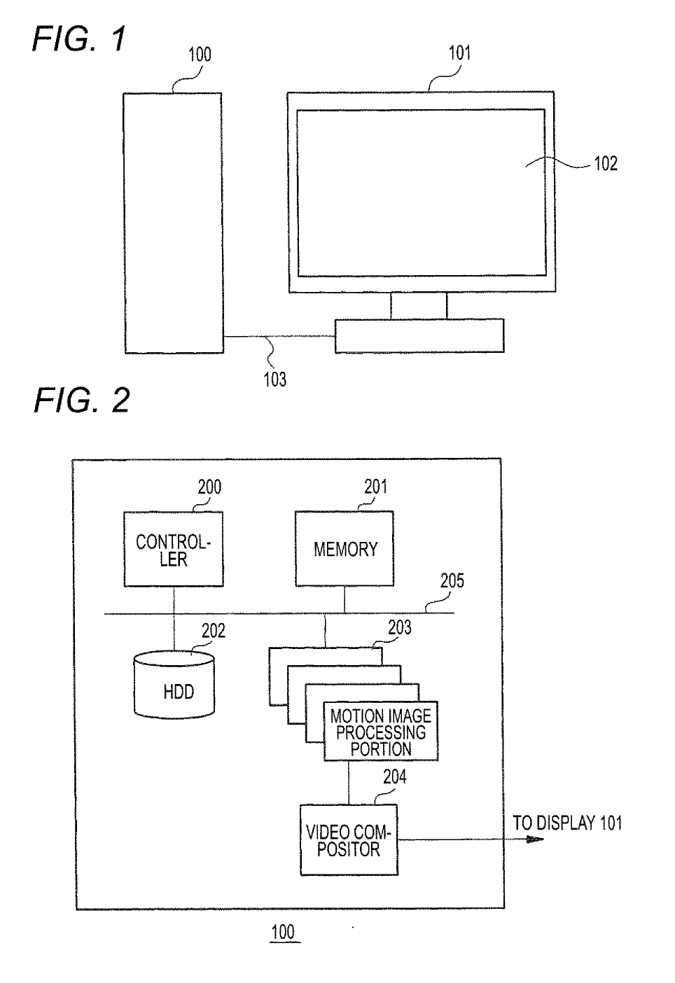

FIG. 1 is a view showing an example of a video reproducing system according to an embodiment of the present invention. In FIG. 1, a video reproducing apparatus 100, a display 101, a display screen 102, and a cable 103 are shown.

The video reproducing apparatus 100 has a function of reproducing and outputting digital contents of a motion image (video image) as a video signal. The digital contents may be previously stored in the video reproducing apparatus 100, or supplied from external device as such by digital broadcasting or through the Internet.

The display 101 has a function of visually displaying an incoming video signal to the user. The display 101 may be a display device for a PC (Personal computer), or alternatively may be a television set having a video input function.

The display screen 102 is a display screen of the display 101. A video signal supplied from the video reproducing apparatus 100 is displayed as an image on the display screen 102.

The cable 103 connects between the video reproducing apparatus 100 and the display 101, and transmits the video signal output from the video reproducing apparatus 100 to the display 101.

FIG. 2 is a view showing an example of a block diagram of the video reproducing apparatus 100 according to the embodiment. In FIG. 2, a controller 200, a memory 201, an HDD 202, video processors 203, a video compositor 204, and a bus 205 are shown.

The controller 200 controls other components provided in the video reproducing apparatus 100. The controller 200 may be configured by a CPU (Central Processing Unit) and a plurality of control circuits.

The memory 201 is configured by a semiconductor memory device, and, when the controller 200 operates, used mainly as a work area and a temporary storage area. Alternatively, the memory 20 may include a nonvolatile memory device, and be used also for storing preset values of the video reproducing apparatus 100, and the like.

The HDD 202 is a storage device configured by a magnetic disk device. Digital contents including a motion image are stored in the HDD, and can be read out as required by another component.

The video processors 203 have functions of receiving the digital contents including the video image, and outputting video information. The video reproducing apparatus 100 in the embodiment includes a plurality of video processors 203, and is configured so that each of the processors can independently output video information from the digital contents. In a case where a processing power is sufficient, the configuration where a plurality of video processors 203 are disposed may not be employed, and a single video processor 203 may process a plurality of digital contents by time sharing. The number of the video processors is not limited to four as illustrated, and the video processors may be disposed in any number as required.

The video compositor 204 has functions of producing one image based on the outputs of the video processors 203, and outputting a video signal of the image. The portion has also functions of producing additional information to be displayed on the screen, other than video data, such as an icon indicating a reproduction position in the contents, and a time display, and adding the information to the output image. The video signal of the output image is sent to the display 101.

The bus 205 governs data transfer between the components in the video reproducing apparatus 100, and enables communications between the components.

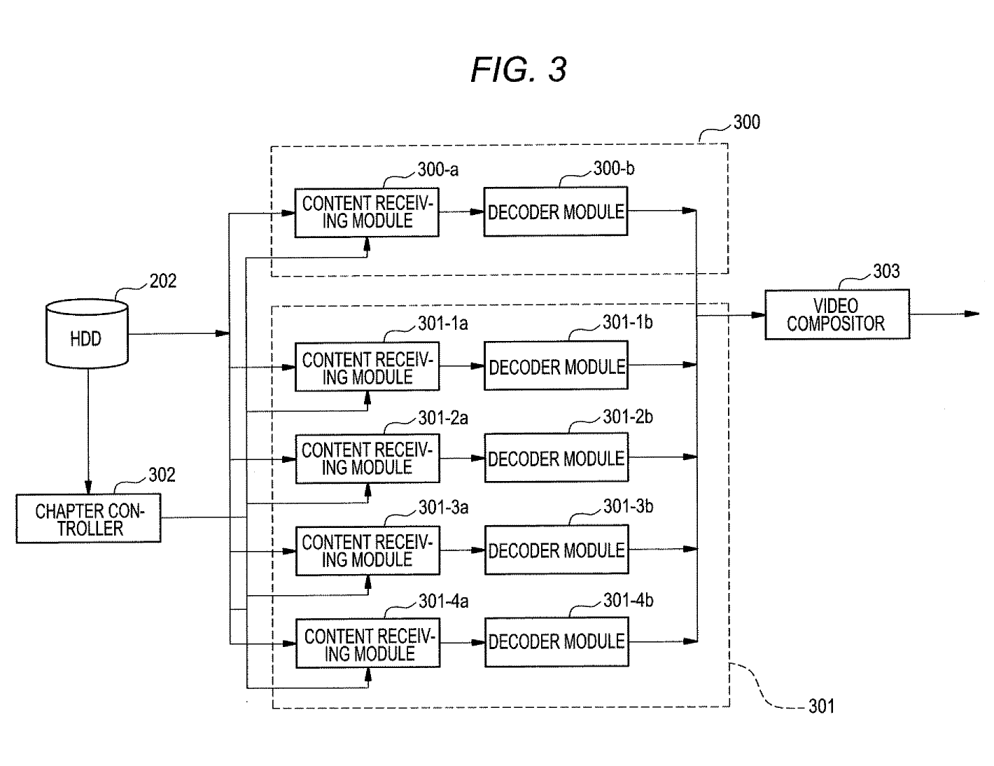

FIG. 3 is a view showing an example of a functional block diagram of the video reproducing apparatus in the embodiment. In FIG. 3, a full-screen video generating module 300, a chapter screen video generating module 301, a chapter controller 302, and a video compositor 303 are shown.

The full-screen video generating module 300 has functions of reading the digital contents containing the video information, and outputting video information. A content receiving module 300-a and a decoder module 300-b are disposed in the portion. The content receiving module 300-a reads image data corresponding to a desired reproduction time from the digital contents stored in the HOD 202, and transfers the data to the decoder module 300-b. The decoder module 300-b generates video information from the incoming video information. The full-screen video generating module 300 performs an image reproducing process on a video image to be displayed on the whole display screen 102.

In contrast that the full-screen video generating module 300 performs the process of reproducing a video image to be displayed on the whole display screen 102, the chapter screen video generating module 301 has a function of reducing and displaying a video image in a chapter contained in the contents, in a chapter displaying region. A plurality of combinations of a content receiving module 301-a and a decoder module 301-b are disposed in the chapter screen video generating module 301. In the embodiment, four combinations of 1a and 1b to 4a and 4b are disposed. The number of the combinations is increased or decreased as required in accordance with the number of chapters which are to be simultaneously displayed as motion images. When an n number of chapters are to be displayed, namely, the same or n number of combinations are required.

The chapter controller 302 has functions of obtaining chapter information from the video information of the digital contents stored in the HDD 202, and outputting the information to the full-screen video generating module 300 and chapter screen video generating module 301 which reproduce a motion image. Specifically, for example, the content receiving module obtains the reproduction time of a desired chapter contained in the chapter information, and the read position of the digital contents is caused to jump to the reproduction time, thereby enabling a motion image to be reproduced from the desired chapter.

The video compositor 303 has a function of combining the output videos of the full-screen video generating module 300 and the chapter screen video generating module 301 with each other to generate one set of video information. At this timer also an additional information display such as a time bar and the reproduction time which are to be displayed on the screen is combined with the information.

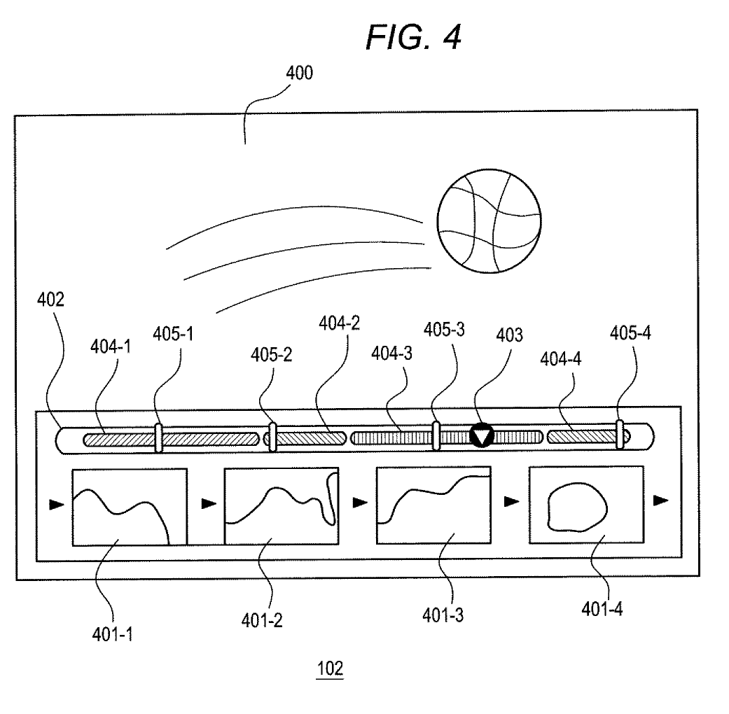

FIG. 4 is a view showing an example of a video image display screen in the embodiment. In FIG. 4, a full screen 400, chapter screens 401, a time bar 402, a full-screen reproduction position 403, chapter ranges 404, and chapter reproduction positions 405 are shown.

The full screen 400 is a screen region where a main video which is displayed on the whole display screen 102 is shown. In FIG. 4, a chapter display and the like are displayed in a lower area of the display screen 102, and a part of the full screen 400 is hidden and unseen. In the case where the main video is to be normally viewed, only the main video of the full screen 400 is displayed.

The chapter screens 401 are screen regions in each of which a motion image of a chapter range contained in a motion image of the digital contents is displayed in the form of a reduced motion image. In the embodiment, an example in which four chapter screens 401-1 to 401-4 are displayed is shown. As the chapter screen is in a more rightward position, a motion image of a chapter which is designated at a more recent time is displayed.

The time bar 402 displays the range of the reproduction time of the whole or part of the reproduced motion image, as a time axis which is directed from the left to the right.

The full-screen reproduction position 403 indicates a position corresponding to the reproduction time of the video image which is being reproduced on the full screen 400, in the time range which is being displayed in the time bar 402. As the reproduction of the video image is more advanced, the position is gradually moved further rightward. When the position is moved to the right end of the time bar 402, the title end of the video image of the digital contents is set.

The chapter ranges 404 indicate the reproduction time ranges of chapters which divide the range displayed by the time bar 402, respectively. In the embodiment, the four chapter screens 401 are used, and hence four chapter ranges 404-1 to 404-4 are displayed. In the sequence starting from the left side, the chapter ranges indicate the reproduction time ranges of the chapter screens 401-1 to 401-4, respectively.

In order to facilitate intuitive understanding, the example in which the chapter ranges 404 and the chapter screens 401 sequentially correspond to each other in the direction of the time axis of the time bar 402 is shown. In the case where the correspondence relationships between the chapter ranges 404 and the chapter screens 401 are displayed so as to be correlatingly recognizable by the display color, the shape, and other identification, however, the ranges and screens may not always be displayed in the illustrated sequence.

Each of the chapter reproduction positions 405 indicates positions where the motion image reproduced in the corresponding chapter screen 401 is reproduced, in the chapter range. When the reproduction position of the video image reproduced in the corresponding chapter screen 401 reaches the end of the chapter range 404, the chapter reproduction position 405 is changed to the starting position of the chapter range 404. Each of the chapter reproduction positions 405-1 to 405-4 is moved in conjunction with the corresponding one of the chapter screens 401-1 to 401-4, and not with reproduction of the other not-corresponding chapters, or the other chapter reproduction positions 405.

According to the configuration, a chapter range is repeatedly reduced and displayed so as to always generate a motion image, so that the context is understood more easily than the case of a still image. Furthermore, the chapter ranges are displayed so as to be separated from one another in the time bar, and the production positions of the displayed motion images of the respective chapter screens are displayed in the time bar, whereby the motion images can be provided with a conventional thumbnail display.

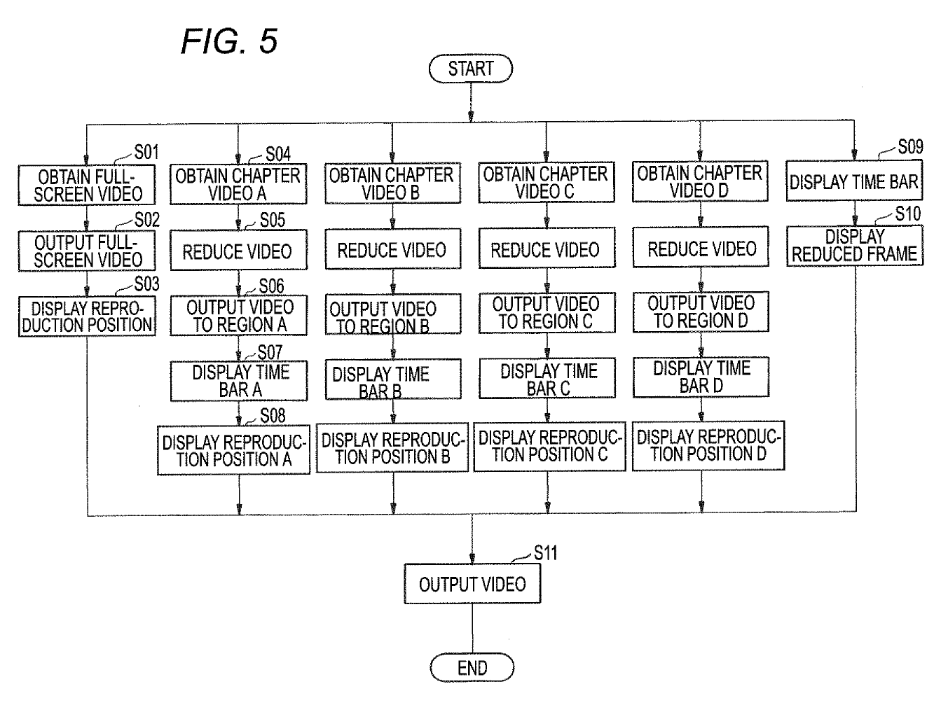

FIG. 5 is a view showing an example of a motion image display flow in the embodiment.

First, the full-screen video generating module 300 obtains video information to be displayed on the full screen 400, from the digital contents stored in the HDD 202 (step S01). Next, the obtained video information is decoded, and then output as full-screen video information (step S02). Then, the display position of the full-screen reproduction position 403 to be displayed in the time bar 402 is specified, and video information is output so that the position is combined with the video signal (step S03).

In parallel with this, a certain chapter (referred to as chapter A) contained in a motion image of the digital contents is reduced and displayed. First, the chapter screen video generating module 301 obtains video information to be displayed in the chapter screen 401, from the digital contents stored in the HDD 202 (step S04). Next, the obtained video information is decoded, and reduced to the size of the chapter screen 401 (step S05), and then output as chapter screen video information (step S06). Then, time bar A is displayed in the range of the time bar 402 and corresponding to the reproduction time range of chapter A (step S07) to specify the display position of the chapter reproduction position 405, and video information is output so that the position is combined with the video signal (step S08).

Similarly, the other chapters are processed in parallel while specifying chapters B, C, and D, respectively.

Furthermore, display information of the time bar 402 to be displayed on the full screen 400 is generated (step S09), and additional information such as the frames of reduced display screens is generated (step S10).

Finally, sets of video information which are generated by the full-screen video generating module 300 and the other configuration are combined with one another in the video compositor 303, and one output video is output (step S11).

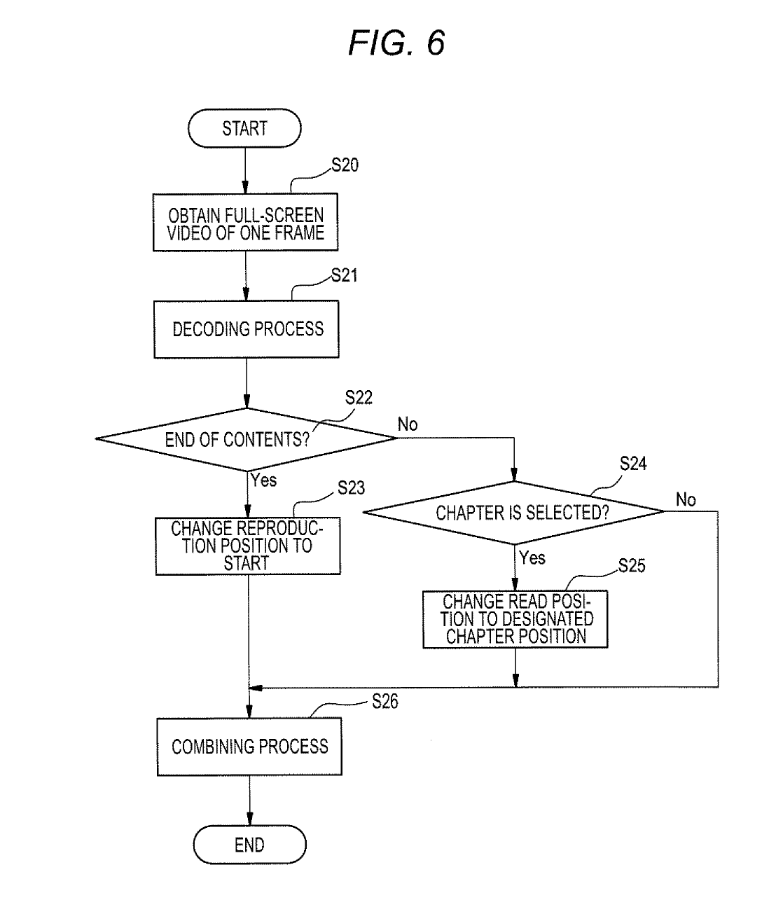

FIG. 6 is a view showing an example of a full-screen display flow in the embodiment.

First, the content receiving module 300-a obtains image information of one frame which is to be processed among motion images of the digital contents that are being reproduced (step S20). Next, the decoder module 300-b decodes the image information to generate video information (step S21).

Then, it is determined whether the reproduced contents reach the end or not (step S22). If the end (Yes), the full-screen reproduction position 403 is again displayed at the start of the time bar 402, and the production position is changed so that reproduction is performed from the start of the contents (step S23).

If the reproduced contents do not reach the end (No) it is determined whether a new chapter to be displayed on the full screen 400 is selected or not (step S24). If selected (Yes), the content read destination of the content receiving module 300-a of the full-screen video generating module 300 is changed to the position of the selected chapter (step S25).

Next, the video information generated in step S21 is output to the video compositor 303, and the process of combining the images is performed (step S26). Then, the series of flows is ended.

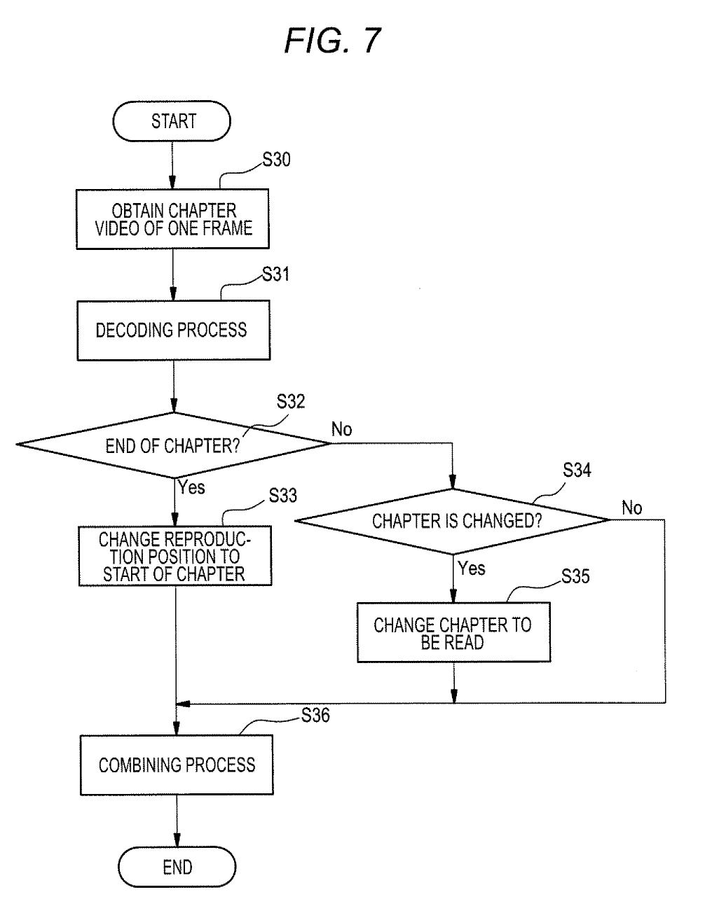

FIG. 7 is a view showing an example of a chapter display flow in the embodiment.

First, the content receiving module 301-a obtains image information of one frame which is to be next processed among motion images of the digital contents that are under chapter reproduction (step S30). Next, the decoder module 301-b decodes the image information to generate video information which is reduced to the size of the chapter screen 401 (step S31).

Then, it is determined whether the reproduced chapter reaches the end or not (step S32). If the end is reached (Yes), the chapter reproduction position 405 is again displayed at the start of the chapter range 404 corresponding to the chapter, and the production position is changed so that reproduction is performed from the start of the chapter (step S33).

If the reproduced chapter does not reach the end (No) it is determined whether the chapter to be displayed in the chapter screen 401 is changed or not (step S34). If changed (Yes), the content read destination of the content receiving module 301-a of the chapter screen video generating module 301 is changed to the position of the selected chapter (step S35).

Next, the video information generated in step S31 is output to the video compositor 303, and the process of combining the images is performed (step S36). Then, the series of flows is ended.

According to the configuration, with respect to a chapter which is contained in video contents, and the context of which is hardly understood unless the contents are displayed in the form of a motion image, the context can be displayed in an easily understood manner.

As described above with reference to the embodiment, with respect to a chapter which is contained in video contents, and the context of which is hardly understood unless the contents are displayed in the form of a motion image, the context can be displayed in an easily understood manner.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A video reproducing apparatus comprising:
a plurality of image generating modules each configured to repeatedly generate video image from a video content simultaneously for each of chapters contained in the video content; and
an image processing module configured to combine the video images generated by the image generating modules into a single video information and to output the video information.

2. The apparatus of claim 1, wherein the image processing module comprises a time bar generating module configured to generate a first time bar image that represent a first time bar indicating a range of a reproducing time from a beginning to an end of the video content,
wherein the first time bar is divided by a plurality of second time bars each indicating a range of a reproducing time from a beginning to an end of the respective chapters.

3. The apparatus of claim 2, wherein the time bar generating module comprises a reproduction position generating module configured to generate images representing reproduction positions of the video images currently being generated in the respective chapters for the respective second time bars.

4. The apparatus of claim 2, wherein the image processing module comprises a video identification module configured to add identification display to the respective video images for identifying each of the video images, and
wherein the time bar generating module comprises a time bar identification module configured to add the identification displays to the respective second time bars corresponding to the video images being added with the respective identification displays.

5. The apparatus of claim 4, wherein each of the identification displays is a frame of the respective video image and color information of the respective second time bars.

6. A method for reproducing video, the method comprising:
repeatedly generating video image from a video content simultaneously for each of chapters contained in the video content by a plurality of image generating modules; and
combining the video images by an image processing module into a single video information to output the video information.

7. The method of claim 6 further comprising:
generating a first time bar image that represent a first time bar indicating a range of a reproducing time from a beginning to an end of the video content by the image processing module; and
generating a plurality of second time bars dividing the first time bar, each of the second time bars indicating a range of a reproducing time from a beginning to an end of the respective chapters.

8. The method of claim 7 further comprising generating images representing reproduction positions of the video images currently being generated in the respective chapters for the respective second time bars.

9. The method of claim 7 further comprising:
adding identification display to the respective video images for identifying each of the video images; and
adding the identification displays to the respective second time bars corresponding to the video images being added with the respective identification displays.

10. A computer-readable storage medium containing a program executable by a computer system to cause the computer system to operate in accordance with a sequence of procedure, the procedure comprising:
repeatedly generating video image from a video content simultaneously for each of chapters contained in the video content by a plurality of image generating modules; and
combining the video images by an image processing module into a single video information to output the video information.

11. The computer-readable storage medium of claim 10, wherein the procedure further comprising:
generating a first time bar image that represent a first time bar indicating a range of a reproducing time from a beginning to an end of the video content by the image processing module; and
generating a plurality of second time bars dividing the first time bar, each of the second time bars indicating a range of a reproducing time from a beginning to an end of the respective chapters.
